(19) United States
(12) Patent Application Publication
(10) Pub. No.: US 2019/0087468 A1
(43) Pub. Date: Mar. 21, 2019

(54) STATUS STREAMING POP-UP MAP

(71) Applicant: PAG Financial International LLC, Guaynabo, PR (US)

(72) Inventors: PAVAN AGARWAL, Cerritos, CA (US); JONATHAN ORTIZ RIVERA, Cerritos, CA (US); GABRIEL ALBORS SANCHEZ, Cerritos, CA (US)

(73) Assignee: PAG Financial International LLC, Guaynabo, PR (US)

(21) Appl. No.: 15/706,566

(22) Filed: Sep. 15, 2017

(51) Int. Cl. G06F 17/30; G06Q 50/00

(52) U.S. Cl. CPC G06F 17/30539; G06F 17/30861; G06F 17/30029; G06Q 50/01

(57) ABSTRACT

Various embodiments of the present invention provide a system and method for providing a digital status indicator on a map. According to one embodiment, a system is provided which performs the operations of: parsing through social media data of a social media user extracted from a social media platform; creating a status indicator comprising one or more categorical labels to filter the social media data into select categories of interest;; correlating the status indicator with location information; outputting the status indicator with location information on a map interface; and presenting through a graphical user interface the status indicator with the location information.

### TECHNICAL FIELD

The disclosed technology relates generally to providing a digital status indicator, and some embodiments relate to methods and systems of providing a digital status indicator on a map.

### BACKGROUND

The internet and various social media platforms (e.g., Facebook®, Twitter®, Instagram®, etc.) can provide social media users with an easy-to-use interface for conveying information, opinions, ideas, career interests and other forms of expression. Social media users can log-on to these platforms from their personal computers, cellphones, or other communication devices and convey such expressions or learn about the information of other social media users within a matter of seconds.

While social media users may be able to access and view the information their social media friends post, there currently is no way for a social media user to know what is trending in his or her general geographical vicinity based on the similar interests provided by the mass collection of social media data and information.

### BRIEF SUMMARY OF THE DISCLOSURE

Various embodiments of the present invention provide a computer implemented method and a system for displaying one or more categorized statuses, also referred herein as a categorized status indicator, on a map interface in real time. The categorized statuses may be generated by parsing the social media data into select categories. For example, the categories may cover a wide range of topics that reveal information collected from the social media users, such as gender, relationship status, education, number of kids, occupation, hometown, hobbies, and the like.

In accordance with one embodiment of the present disclosure, the method includes obtaining social media data of a social media user extracted from a social media platform; creating a status indicator comprising one or more categorical labels to filter the social media data into select categories of interest; correlating the status indicator with location information of the social media users associated with the status indicator; and outputting the status indicator with location information on a map interface.

In accordance to another embodiment, a system is provided that includes a process, a memory attached to the processor; and a computer readable medium having instructions embedded therein. The computer readable instructions may be configured to cause the processor to perform the operations of: parsing through social media data of a social media user extracted from a social media platform; creating a status indicator comprising one or more categorical labels to filter the social media data into select categories of interest; correlating the status indicator with location information; outputting the status indicator with location information on a map interface; and presenting through a graphical user interface the status indicator with the location information.

In accordance with another embodiment, the computer readable instructions may be configured to cause the processor to perform the operations of parsing through social media data of a social media user extracted from a social media platform; associating a business with a status indicator, wherein the status indicator is a categorical label to indicate a name of a business; correlating the status indicator with location information; outputting the status indicator with location information on a map interface; and presenting through a graphical user interface the status indicator with the location information.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example environment in which various embodiments may be implemented.

FIG. 2 illustrates an example environment in which various embodiments may be implemented for obtaining location data.

FIG. 3A is an operational flow diagram illustrating an example process for providing a status indicator in accordance with various embodiments.

FIG. 3B is an operational flow diagram illustrating an example process for generating a status indicator on a map interface in accordance with various embodiments.

FIG. 4 illustrates an example map interface for presenting and interacting with a status indicator in accordance with various embodiments.

FIG. 5 illustrates an illustrates an example GUI for presenting and interacting with an information page associated with status indicator as depicted in FIG. 4.

FIG. 6 is an example communications system with which various embodiments may be implemented.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

As previously discussed, the internet and social media have become a popular and mainstream way for users to connect with others in a virtual environment. Social media platforms may allow people to share personal information about themselves and even convey their likes and interests to other social media users on social media platforms. One example of expressing such likes and interests may be done by pressing the “like” button feature that conveys their public support for specific comments, pictures, wall posts, statuses, or fan pages. In another example, social media users may also indirectly convey his or her interests and hobbies by inputting such information directly on their profile page.

Because meeting people in the real world can often be difficult in a social setting, it is often easier to start and maintain a conversation when two people have similar personal and social interests. As such, the aforementioned systems and methods may include displaying one or more categorized statuses on a map in real time to allow a user to locate areas trending with other social media users with similar interests. In other instances, the systems and methods may allow a user to locate areas with a certain type of crowd composition, such as young working professionals or single men. The categorized statuses may be generated from the collection of social media data from other social media users to indicate the general type of social media users located in that area based on their likes and interest as indicated on various media platforms.

In other embodiments, the categorized statuses may be the names of businesses generated on a map to allows users to see how many other social media users are also located or waiting at those businesses. The businesses may be generated on a map based on businesses that the social media users are currently visiting, where such real-time data may be collected from the location information of the social media user. This may then allow the user to determine which businesses to go to based on the number of social media users located at those businesses. Additionally, it should be noted that the aforementioned systems and methods may be an application or a software program to be downloaded onto a mobile device or computer. For simplicity, application and software programs for mobile devices and computers will be referred hereinafter as an “app.”

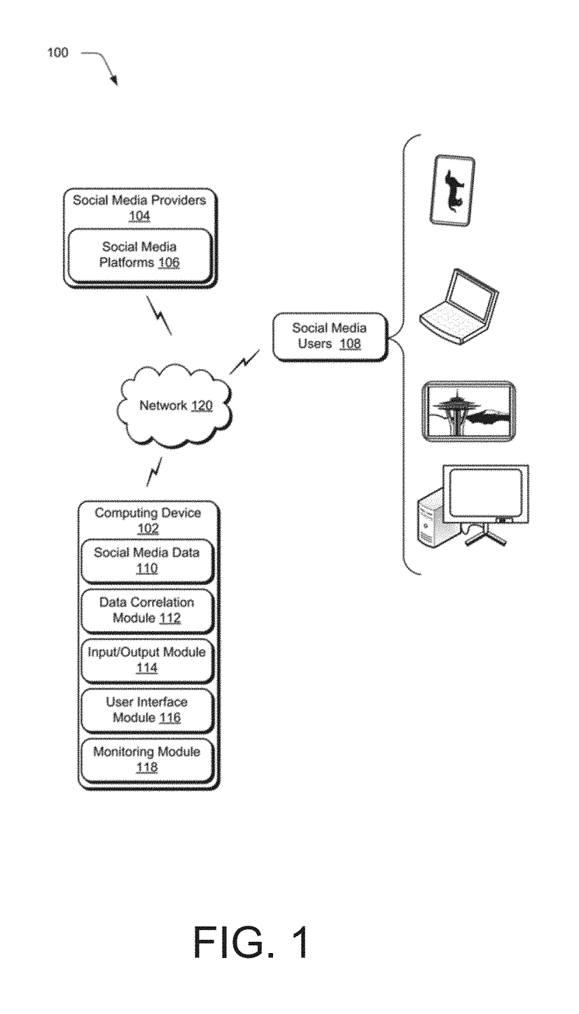

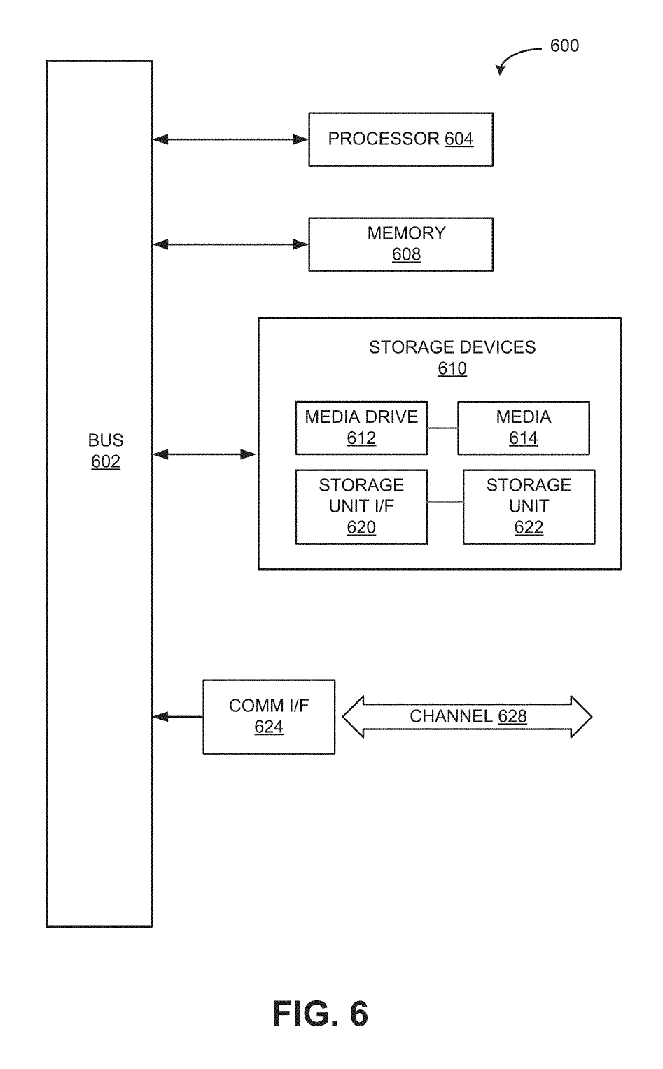

FIG. 1A is an illustration of an environment in an example implementation that is operable to employ techniques for correlating social media data with location environment. Environment 100 includes a computing device 102 which can be configured in a variety of ways, examples of which are described in FIG. 6. Additionally, it should be noted that the computing device 102 may include a mobile device, such as cellphones, smart phones, tablets, and the like. The computing device 102 may be used to implement an app for displaying one or more categorized statuses displayed on a map in real time.

The environment 100 further includes social media providers 104, which are representative of various enterprises and/or services that provide social media platforms 106 which different users may interact and communicate. For instance, the social media platforms 106 can include web-based portals for social interaction. At least some of the social media platforms 106, for instance, can include web pages that enable users to view and post content.

Social media users 108 are illustrated, which are representative of users which may interact via the social media platforms 106. For instance, the social media users 108 may create accounts with different social media platforms 106. Utilizing the accounts, the social media users 108 can post various types of content (e.g., messages), photographs, video, audio, and so on. The social media users 108 can also utilize the social media platforms 106 to rate various content and/or entities, such as indicating a preference (e.g., “liking”) for particular contents posted.

Further embodiments discussed herein, the computing device 102 can retrieve social media data 102 from the social media providers 104. In some instances, only select information from the social media providers 104 may be retrieved, depending on the privacy settings of the social media users which may permit or restrict select information from being public. In other instances, full social media mining such that all any information that can be retrieved from the accounts of the social media users is obtained.

The social media data 110 can include various types of data, such as content posted to the social media platforms 106, geographic region identifiers associated with posted content, keywords extracted from posted content, keywords provided by users in advance, and so on. For instance, if a social media user likes a comment or a post posted by another social media user, the social media data 110 may extract the type of content the social media user prefers. The social media data 110 may also extract from comments posted by the social media user. For example, the social media data 110 extracted from the comment can include keywords (e.g., “foodie,” “love food,” “love ice-cream) and so forth.

Additionally, the collection social media data 110 may even identify what businesses, restaurants, or activities are trending based on information also extracted from comments. For example, if a user posts a comment that identifies a particular restaurant, and includes the phrase “Best pasta evert” the social media data 110 extracted from the comment can include the name of the restaurant, keywords extracted from the comment (e.g., “food” and “best”). As detailed elsewhere herein, the social media data 110 can be leveraged to determine location based information for various products, services, entities, and so on.

The computing device 102 may include various functionalities for managing and processing the social media data 110. For instance, a data correlation module 112 is included, which is representative of functionality to process the social media data 110 and identify various attributes of the social media data. For instance, the data correlation module 112 can parse through the social media data 110 to identify keywords, geographical information, sentiment information (e.g., likes/dislikes associated with different content and/or entities), and so on.

However, it should also be mentioned that information may also be mined from the user's device. The data mined from the user's device (e.g., tablet, smartphone, laptop, desktop, etc.) may be collected and analyzed within the correlation module 112 and into a database. The information may include any that is collected from the device, such as location information, device user information, and any other information collected and stored on the user's device.

The computing device 102 further includes an input/output (I/O) module 114, which is representative of functionality to manage various aspects of graphical user interfaces discussed herein. For instance, the user interface module 116 can cause processed social media data 110 to be displayed via the computing device 102. The user interface module 116 may also provide interactive interfaces via which a user can provide input and/or navigate (e.g., search) the processed social media data 110.

The computing device 102 further includes a monitoring module 118, which is representative of functionality to monitor social media data for various criteria. As detailed elsewhere herein, the social media data can be monitored for various criteria and alerts can be generated upon the occurrence of specified criteria.

The environment 100 may further include one or more networks 120 via which various entities of the environment 100 may communicate. The network(s) 120 may assume a variety of different configurations, such as a local area network (LAN), a wide area network (WAN), the Internet, and so forth.

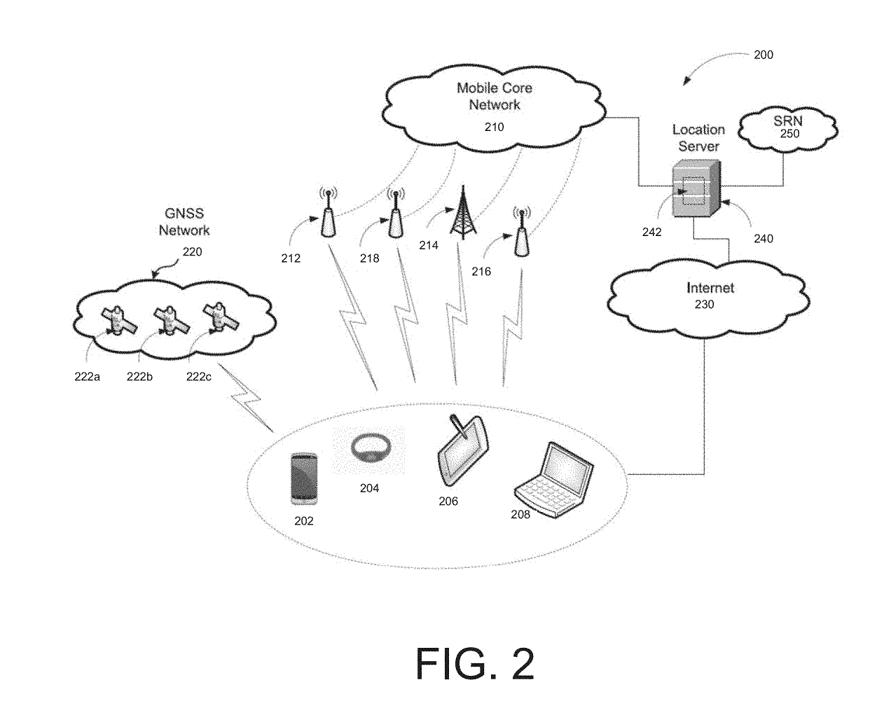

As described previously, various embodiments include generating and outputting social media data on a map in real time. FIG. 2 is a block diagram illustrating an example communication system 200 in which various embodiments may be implemented in accordance with the present disclosure for achieving such location-based aspects of the various embodiments. Communications system 200 may include a plurality of mobile devices, of which mobile devices 202-208 are illustrated. Example mobile devices may include a smart phone 202, an identification device, such as an NFC ID band 204, a tablet PC 206, and/or a laptop PC 208. Also shown in communication system 200 is a mobile core network 210, a wireless access point (AP) 212, a cellular base station (BS) 214, a Bluetooth® emitter 216, an NFC terminal 218, a global navigation satellite system (GNSS) network 220, a plurality of GNSS satellites 222a-222n, an internet 230, a location server 240, and a satellite reference network (SRN) 250. One or more of mobile core network 210, wireless AP 212, cellular BS 214, Bluetooth® emitter 216, NFC terminal 218, GNSS network 220, GNSS satellites 222a-222n, internet 230, location server 240, and/or satellite reference network (SRN) 250 can be used to determine the location of one or more of the mobile devices 202-208 and/or for determining the location of at least one user relative to another user. One or more or all of the networks illustrated in FIG. 2 may be an embodiment of network 120 of FIG. 1 or may be additional networks over which the various elements of FIG. 1 may communicate and/or interact.

Wireless AP 212 may include suitable logic, circuitry, interfaces, and/or code that are operable to provide data services to communication devices, such as one or more of the mobile devices 202-208, in adherence with one or more wireless LAN (WLAN) standards such as, for example, IEEE 802.11, 802.11a, 802.11b, 802.11d, 802.11e, 802.11n, 802.11 ac, 802.11v, and/or 802.11u. Wireless AP 212 may communicate with mobile core network 210 and/or internet 230, via one or more links and/or associated devices for example. In this manner, wireless AP 212 may provide network access to mobile devices 202-208.

Cellular BS 214 may include suitable logic, circuitry, interfaces, and/or code that are operable to provide voice and/or data services to communication devices, such as one or more of the mobile devices 202-208, in adherence with one or more cellular communication standards. Exemplary cellular communication standards may include Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE). Cellular BS 214 may communicate with mobile core network 210 and/or internet 230, via one or more backhaul links and/or associated devices for example. In this manner, cellular BS 214 may provide network access to mobile devices 202-208, enabling a mobile device, such as smart phone 202, to communicate with one or more databases, services, servers, networks, or interactive media walls as described herein.

Bluetooth® emitter 216 may include suitable logic, circuitry, interfaces, and/or code that are operable to provide Bluetooth® based connectivity to communication devices, such as one or more of mobile devices 202-208, in adherence with various Bluetooth® and/or Bluetooth® Low Energy (BLE) standards. Bluetooth® emitter 216 may communicate with mobile core network 210 and/or internet 230, via one or more backhaul links and/or associated devices for example. In this manner, Bluetooth® emitter 216 may provide network access to mobile devices 202-208, enabling a mobile device, such as smart phone 202 to communicate with one or more entities of system 200.

NFC terminal 218 may include suitable logic, circuitry, interfaces, and/or code that can provide NFC-based connectivity to communication devices, such as one or more of the mobile devices 202-208, in adherence with various short range communication standards such as the Near Field Communications standards. The NFC terminal 218 may communicate with the mobile core network 210 and/or the internet 230, via one or more backhaul links and/or associated devices for example. In this manner, the NFC terminal 218 may provide network access to the mobile devices 202-208. Alternatively, NFC functionality may be resident within each of the mobile devices 202-208.

Mobile core network 210 may include suitable logic, circuitry, interfaces, and/or code that are operable to provide interfacing and/or connectivity servicing between access networks, which may be utilized by the mobile devices 202-208, and external data networks such as packet data networks (PDNs) and/or internet 230. Mobile core network 210 may correspond to one or more service providers that provide, control, and/or manage network accessibility available via mobile devices 202-208. In this regard, mobile devices 202-208 may access the mobile core network 210 via wireless AP 212, cellular BS 214, Bluetooth® emitter 216, and/or NFC terminal 218. Mobile core network 210 may communicate various data services, which are provided by external data networks, to associated user devices such as, for example, mobile devices 202-208. In an example aspect of the disclosure, mobile core network 210 may be operable to communicate with location server 240 to obtain location information that can be used to ascertain the relative locations of mobile devices 202-208.

Each of mobile devices 202-208 may include suitable logic, circuitry, interfaces, and/or code for implementing various aspects of the embodiments disclosed herein. In this regard, each of mobile devices 202-208 may be operable to communicate via a plurality of wired and/or wireless connections. Each of mobile devices 202-208 may be operable, for example, to transmit to and/or receive signals from one or more of wireless AP 212, cellular BS 214, Bluetooth® emitter 216, NFC terminal 218, GNSS network 220, and/or internet 230. Also, each of mobile devices 202-208 may be operable to communicate with, and/or receive services provided by internet 230 and/or mobile core network 210.

GNSS network 220 may include suitable logic, circuitry, interfaces, and/or code that may provide navigation information to land-based devices via satellite links. In this regard, GNSS network 220 may include, for example, a plurality of GNSS satellites 222a-222c, each of which is operable to provide satellite transmissions based on a GNSS, enabling land-based devices, such as the mobile devices 202-208, to determine their locations. SRN 250 may include suitable logic, circuitry, interfaces, and/or code that are operable to collect and/or distribute data for GNSS satellites on a continuous basis. SRN 350 may include a plurality of GNSS reference tracking stations located around the world to provide A-GNSS coverage all the time in both a home network and/or any visited network.

Location server 240 may include suitable logic, circuitry, interfaces, and/or code that are operable to provide and/or support location based services. In this regard, location server 240 may be operable to store and/or process location related information pertaining to communication devices in system 200, such as one or more of mobile devices 302-308, as well as the location of other entities, such as points of interest, merchants, etc. It should be noted that location server 240 may access and/or communicate with other location servers/services (not shown) for the purpose of associating a location of communication devices in system 200 with known locations of other entities, points of interest, etc. The location information may be stored in a location reference database 242 in location server 240. Location server 240 may be operable to collect and/or retrieve location information from communication devices. Location server 240 may communicate the stored location data when requested to do so.

In operation, location server 240 may maintain, for example, location reference database 242, which may include elements corresponding to each of mobile devices 302-308. Location server 240 may access SRN 250 to collect GNSS satellite data, and may utilize the collected GNSS satellite data to generate GNSS assistance data (A-GNSS data) pertaining to the mobile devices 202-208. Location server 240 may also collect and/or retrieve location information directly from mobile devices 202-208, and/or from other associated entities that interact with mobile devices 202-208 in system 200, such as, for example, wireless AP 212, cellular BS 214, Bluetooth® emitter 216, and/or NFC terminal 218. The retrieved location information may be stored in location reference database 242 in location server 240. Location server 240 may communicate the stored location data, e.g., when requested to do so. Location reference database 242, maintained in location server 240, may be modified, refined, and/or updated using retrieved location information. Location information stored and/or maintained by location server 240 may be utilized to augment and/or substitute for location information received and/or generated based on communication with GNSS network 220, for example, when communication with GNSS network 220 is disturbed.

The location data may also be locally generated, and/or maintained thereafter by devices and/or entities other than location server 240. In this regard, location related data, which typically may be generated and/or maintained by location server 240, may be locally generated, maintained, and/or used by mobile devices 202-208, and/or by service providers thereof. Accordingly, devices and/or entities that typically may be serviced by location server 240, such as mobile devices 202-208, may also perform location related servicing locally. Furthermore, locally generated and/or maintained location related data may be uploaded from mobile devices 202-208, and/or service providers thereof, to location server 240. Uploading the location related data may be performed periodically, on request, and/or based on the configuration of the client devices or entities, and/or location server 240 itself. Thus, communication system 200 may be implemented in various embodiments in accordance with the present disclosure for achieving location-based aspects of the various embodiments.

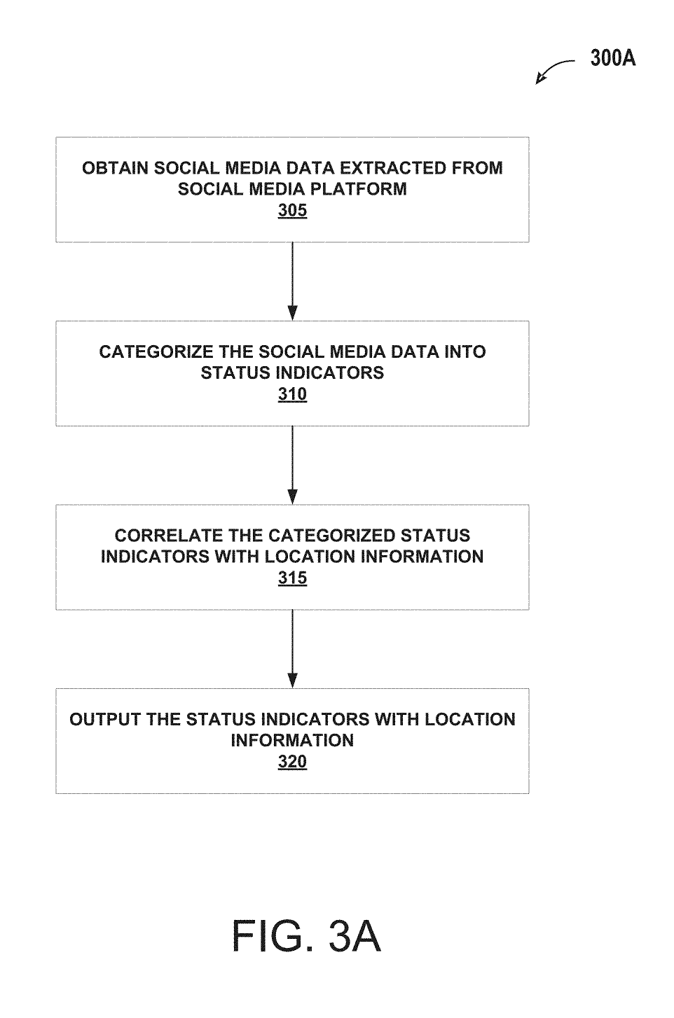

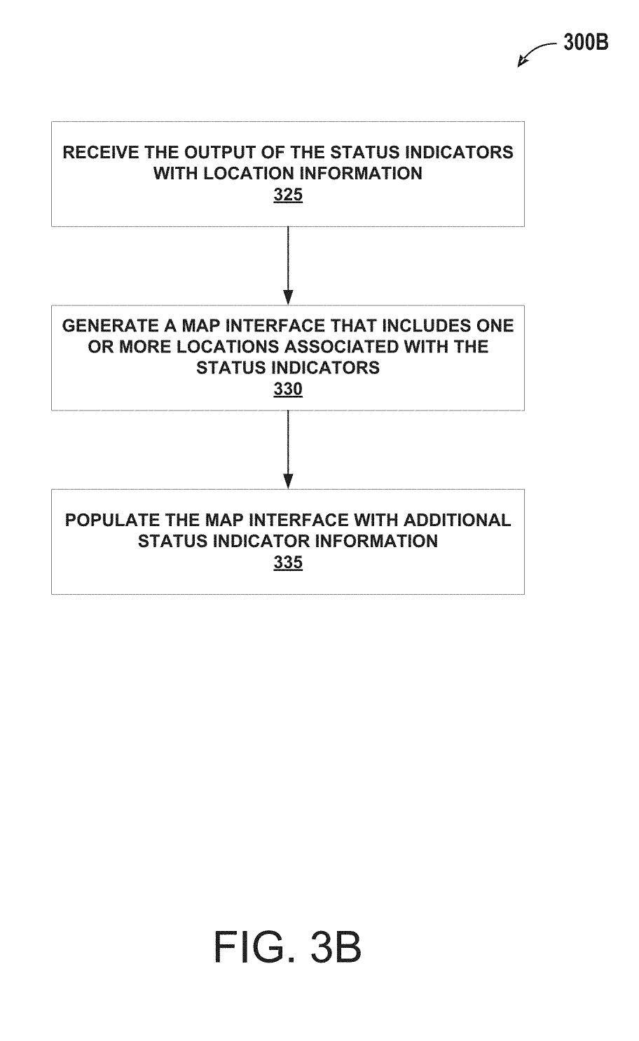

FIG. 3A is an operational flow diagram illustrating an example process 300A for generating an status indicator based on social media data in accordance with various embodiments. At step 305, the social media data may be extracted from a social media platform. In some instances, social media data can be extracted from a social media platform by a separate entity, such as an app via the network (i.e., mobile application). The social media data can be extracted from the app user's one or more social media platforms. By way of example, such data may include sentiment information, which generally refers to an indication of the social media user's attitude toward a particular topic, such as an interest or lack of interest directed to a topic. Furthermore, different levels of sentiment can be detected, based on the number of times the user shows an interest or disinterest to a particular topic.

Other social media data may also be extracted from the social media platform, which may include personal information about the user. Such information may be those that the social media user provides and directly inputs in his or her profile page, which may include gender, relationship status, education, number of kids, occupation, hometown, hobbies, and the like.

Next, the process 300A may proceed to step 310, where the social media data collected may be distinguished and parsed into select categories, or otherwise known as status indicators. For instance, the social media data content may be parsed into categories of interest that the app users may be looking for when attempting to meet or socialize with new groups of people. By way of example only, such select categories may include: single, married, sports fan, pet-lover, dog-lover, cat-lover, food lover, yoga lover, and the like.

Sentiment information can also be parsed and categorized to generate status indicators. For instance, a user can post a comment on a social media platform stating “I love the Chicago Cubs and will always be a Cubs fan—What a great game!” Parsing this comment may indicate sentiment information that the user is a baseball Cubs fan and that the user enjoys watching sports, particularly baseball. Thus, such a post can be associated with a positive sentiment and may categorize its corresponding user with any of the following status indicators: “sports-lover”, “baseball fan,” “CUBS fan,” and the like.

By way of example, the app may extract the social media data from one or more social media platforms. In some instances, the social media data may only be extracted from those accessible to the app user, such as the social media pages of the app user's social media followers and social media friends. In other instances, the app may extract the social media data from all the social media pages of its app users. This may then allow for a larger social media data sample when generating social media data.

At step 315, the parsed social media data that have been categorized into status indicators may be then correlated with location information. Thus, the geographical coordinates can be determined for the users associated with the specific status indicators in real time. For example, if it is determined that many of the social media users tagged as “SINGLE” and are currently amassed in a certain geographical area, the specific geographical region may be identified. In some instances, the social media users tagged as “SINGLE” may all happen to be congregated at a certain business, event, or landmark (e.g. restaurants, clubs, concerts, Disneyland®, San Diego Zoo, etc.). As a result, specific status indicators may be associated with a specific business, event, or landmark. In one instance, the geographical location may be determined by the location server used by mobile devices or the computer devices of the social media users associated with the status indicators.

Next, at step 320, the location information associated with the status indicators may be output. By way of example, such status indicators may be output onto a generated map within the app. In other instances, the status indicators may be output to another application or software, such as Google Maps® or other map interface platforms.

FIG. 3B is an operational flow diagram illustrating an example process 300B for generating outputs on a map interface in accordance with various embodiments. At step 325, the generated status indicators with the location information as described above with respect of FIG. 3A may be received.

Next, at step 330, the status indicators with location information may be generated onto a map interface. For example, if there are 50 social media users the app identifies as being all congregated at a certain concert venue, the app may then indicate that location on the map interface. By way of example, the location information may include the name and address of a business, venue, landmark, or event (herein referred to as “business” in general). By way of example, there may be a visual marker or cue placed on the map interface to visually provide such information to the app user. In some embodiments, the map interface may be sourced from a separate software application, such as Google Maps®, Waze®, Map Quest®, and the like.

Next at step 335, the map interface may include additional information with respect to the status indicators. For example, such information may include the number or app users or social media users located at area associated with the status indicator on the map interface. For example, as discussed in the example above, if there are 50 social media users the app identifies as being all congregated at a certain concert venue, the app may then indicate that there are 50 social media users in the concert hall venue on a map interface. The app may be able to indicate the number of social media users by obtaining the location information of the social media users. Additionally, other information may include the location of the app user on the map interface. This may allow the user to determine how far or close he or she is relative to the status indicators placed on the map interface.

While the status indicator may include the number of social media users at or near the geographical area as indicated on the map interface, the identity of the social media users may be private so that their privacy is and identity is kept private and anonymous to the app users. However, in other instances, the app may provide an external link to each of the social media users associated with the status indicators on the map interface. This may allow the app user to connect with other social media users that the app user is not currently following or befriended.

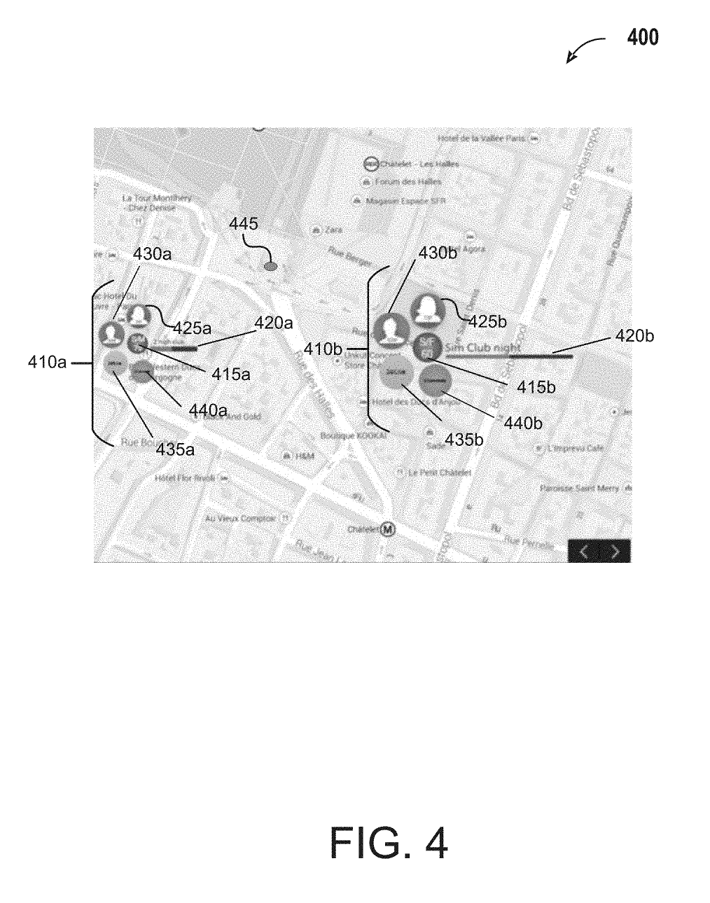

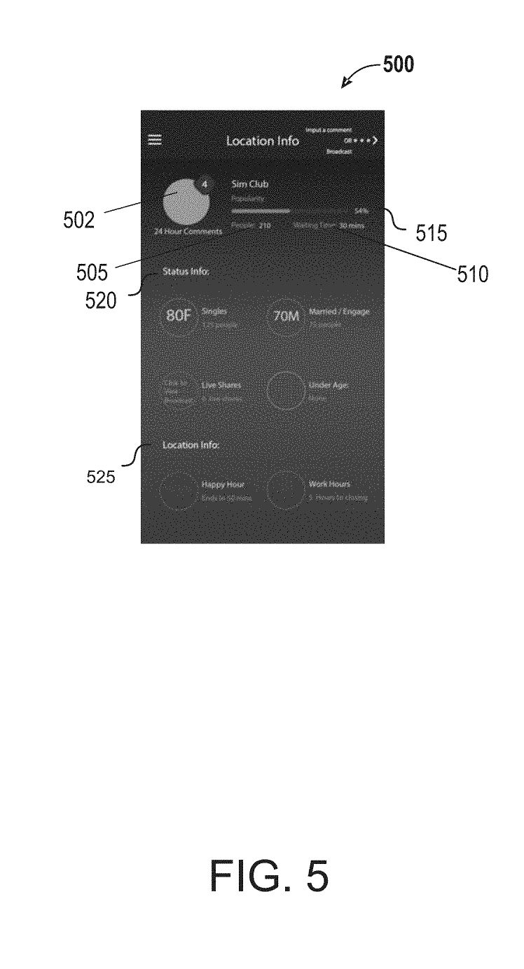

In some embodiments, the status indicator on the map interface may also provide additional information other than the number of social media users located at that geographical area. For example, other information may include the general composition of the grouped social media users congregated at a specific geographical area. For example such information may generate the gender composition, age ranges, relationship statuses, and any other types of information that may indicate the composition of the crowd. More information regarding the information that may be presented on the map interface is provided further below with respect to FIGS. 4-5.

FIG. 4 illustrates an example map interface 400 for presenting and interacting with a status indicator 410a, 410b in accordance with various embodiments. By example, the map interface 400 may be displayed on a GUI that may be implemented to run on an app on a smart phone or any other computing device, such as a tablet, desktop, and the like.

The map interface 400 may include a variety of information to be presented to the app user. For example, such information may include status indicators 410a, 410b which may be the name of a business, event, or venue as well as other additional information. Here, by way of example, the status indicators 410a, 410b provide information for the business “SIM NIGHT CLUB” and 2 general night clubs in the general vicinity.

By way of example, the businesses, events, or venues to be associated with a status indicator 410a, 410b may be the names of business generated from a collection of business data. Thus, any business that is included in the business data may be output onto the map interface 400 as a status indicator 410a, 410b. As further discussed below, the app user may configure the app so that only select business types are displayed on the map interface 400. Here, by way of example, the app user may input a tailored search for nightlife venues, thus resulting in nightlife venues to be populated on the map interface 400.

The status indicators 410a, 410b, may also include other information, such as the types of people at the business. To generate such information, the app may collect such information by collecting social media data from the social media users attending those businesses via the data correlation module. By way of example, such information that may be displayed and presented on the map interface 400 may include a number icon 415a, 415b. The number icon 415a, 415b may indicate the number of social media users the app has data access to that are located at that business based on location retrieval information.

The number of social media users located at that business may be updated in real time, thus allowing the app user to gauge how busy a particular business is at any given moment. Here, in this particular example, the number icons 415a, 415b show that there are 79 social media users at the 2 night clubs at status indicator 410a and 50 social media users at the SIM Club Night at status indicator 410b.

Furthermore, in some embodiments, each of the status indicators 410a, 410b may also provide other information about the social media users attending the particular businesses displayed on the map interface 400. For example, such information may include information such as the number of females 425a, 445b and the number of males 430a, 430b at the identified locations associated with the status indicators 410a, 410b. The gender information may be extracted from the social media data associated with the social media users. Other information regarding the composition of the crowd gathered at the business associated with the status indicators 410a, 410b may be provided, such as the number of social media users that identify themselves as: single, married, sports fan, pet-lover, dog-lover, cat-lover, food lover, yoga lover, and the like.

Additionally, in further embodiments, the map interface 400 may include a wait time indicator 420a, 420b for each of the status indicators 410a, 410b, which may provide an estimated wait time. The estimated weight time may be generated by the input of wait time information from the other app users who are already located at those businesses. By way of example, the app may include a GUI feature that allows the app users to input the wait time. Additionally, in other instances, the business may input the wait time manually via an administrator page associated with the app.

Furthermore, in some embodiments, each of the status indicators 410a, 420b may also include live information icons 435a, 435b. The live information icons 435a, 435b may indicate the number of live posts or comments other app users have posted via the app. By way of example only, the comments posted by the app users may be in real time and may be posted on the app for a select duration. By way of example, the duration may be 24 hours or any other predetermined duration. After the select duration, the comment may then be taken down and removed from the app. This may allow the “live” comments to always remain updated and recent. By way of example, this live comment section may be titled “What's Hot” and allow users to post and share their comments about the venue or event. The live posts or comments may be about the app user's experience or opinion of the business associated with the status indicators 410a, 410b. Thus, in some instances, the app may include a comment window feature that allows an app user to input comments.

In additional embodiments, the status indicators 410a, 410b may include general comment icons 440a, 440b. The general comment icons 440a, 440b indicate the number of posts that have been extracted from the social media platform regarding the businesses associated with the status indicators 410a, 410b. The data correlation module may be able to decipher keywords of the comments posted by the social media user, which may also include the location information of where the comment was posted. For example, if a social media user posts a comment “SIMS CLUB—Best night ever and love the crowd,” the data correlation module may extract that the social media user is commenting about the business associated with the status indicators 410b and post the comment on the app. Furthermore, the location based aspects of the app may further extract location data from the comment and determine that the comment was posted at the business associated with the status indicator 410b. As a result, the posted comment may be associated with location data, which may then be posted on the app. In some instances, the posts and comments may be extracted in real time from the social media platforms so that they are up to date.

In some embodiments, the location of the user 445 may be located on the map interface 400. This may allow the user to see how close or far he or she is from the various status indicators 410a, 410b populated on the map interface 400.

FIG. 5 illustrates an illustrates an example GUI for presenting and interacting with an information page 500 associated with status indicator as depicted in FIG. 4. In some embodiments, the information page 500 may include the location information associated with the corresponding status indicator located on a map interface. In some embodiments, the information page 500 may include the number of people 505 at the business as well as the wait time 510.

In some instances, the information page 500 may include a live information icon 502, which may indicate the number of live comments. Here, there are a total of 4 live comments available for the app user's review.

Additionally, a popularity bar 515 may be included on the information page 500. The popularity bar 515 may be based on the ratings provided by other app users. In some instances, the app may include a rate feature that allows app users to rate the business. In other instances the rating of the business may come from another source, such as another app (e.g., Yelp®, Urbanspoon®, TripAdvisor®, AroundMe®, Foursquare®, YP®).

Additionally, the information page 500 may include additional status information 520 associated with the status indicator. For example, here, the status information 520 may include more detailed information about the crowd, such as the total number of single people (e.g., 125 people), total number of single females (e.g., 80 females), total number of married/engaged people (e.g., 75 people), total number of single males (e.g., 70 males), total number of live shares (e.g., 6 live shares), and under age attendees (e.g., none). As indicated above, the information may be extracted from the social media data of the social media users located the business. By way of example, the status information 520 may categorize other information about the crowd, such as general likes and interests. By way of example, such categories may include: relationship status, education, occupation, hometown, hobbies, sports fan, pet-lover, dog-lover, cat-lover, food lover, and yoga lover. Additionally, the status information 520 may include the number of social media users associated with those categories, which can be determined by filtering through the social media data of the social media users via the data correlation module.

In other instances, the information page 500 may also include location info 525, such as happy hour and work hour info. Other information may include business address, phone number, parking information, and the like.

FIG. 7 is an example communications system with which various embodiments may be implemented. As used herein, the term “system” might describe a given unit of functionality that can be performed in accordance with one or more embodiments of the present invention. As used herein, a system might be implemented utilizing any form of hardware, software, or a combination thereof. For example, one or more processors, controllers, ASICs, PLAs, PALs, CPLDs, FPGAs, logical components, software routines or other mechanisms might be implemented to make up a system. In implementation, the various systems described herein might be implemented as discrete systems or the functions and features described can be shared in part or in total among one or more systems. In other words, as would be apparent to one of ordinary skill in the art after reading this description, the various features and functionality described herein may be implemented in any given application and can be implemented in one or more separate or shared systems in various combinations and permutations. Even though various features or elements of functionality may be individually described or claimed as separate systems, one of ordinary skill in the art will understand that these features and functionality can be shared among one or more common software and hardware elements, and such description shall not require or imply that separate hardware or software components are used to implement such features or functionality.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent system names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Where components or systems of the invention are implemented in whole or in part using software, in one embodiment, these software elements can be implemented to operate with a computing or processing system capable of carrying out the functionality described with respect thereto. One such example-computing system is shown in FIG. 6. Various embodiments are described in terms of this example-computing system 600. After reading this description, it will become apparent to a person skilled in the relevant art how to implement the invention using other computing systems or architectures.

Referring now to FIG. 6, computing system 600 may represent, for example, computing or processing capabilities found within desktop, laptop and notebook computers; hand-held computing devices (PDA's, tablets, smart phones, cell phones, palmtops, etc.); mainframes, supercomputers, workstations or servers; or any other type of special-purpose or general-purpose computing devices as may be desirable or appropriate for a given application or environment. Computing system 600 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 600 might include, for example, one or more processors, controllers, control systems, or other processing devices, such as a processor 704. Processor 704 might be implemented using a general-purpose or special-purpose processing engine such as, for example, a microprocessor, controller, or other control logic. In the example illustrated in FIG. 6, processor 604 is connected to a bus 602, although any communication medium can be used to facilitate interaction with other components of computing system 600 or to communicate externally.

Computing system 600 might also include one or more memory systems, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing system 600 might likewise include a read only memory (“ROM”) or other static storage device coupled to bus 602 for storing static information and instructions for processor 604.

The computing system 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing system 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory system) and memory slot, a PCMCIA slot and card, and other fixed or removable storage units 622 and interfaces 620 that allow software and data to be transferred from the storage unit 622 to computing system 600.

Computing system 600 might also include a communications interface 624. Communications interface 624 might be used to allow software and data to be transferred between computing system 600 and external devices. Examples of communications interface 624 might include a modem or softmodem, a network interface (such as an Ethernet, network interface card, WiMedia, IEEE 902.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 608, storage unit 620, media 614, and signals on channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 600 to perform features or functions of the present invention as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method comprising:
obtaining social media data of a social media user extracted from a social media platform;
creating a status indicator comprising one or more categorical labels to filter the social media data into select categories of interest;
correlating the status indicator with location information of the social media users associated with the status indicator; and
outputting the status indicator with location information on a map interface.

2. The method of claim 1, wherein the social media data comprises extracting sentiment information from a social media user's comments and posts on the social media platform.

3. The method of claim 2, wherein the social media data comprises personal information comprising age, gender, relationship status, education, occupation, hometown, and hobbies.

4. The method of claim 3, wherein the categorical labels comprise information about the social media users associated with the status indicator.

5. The method of claim 4, wherein the categorical labels comprise an age group, gender identification, relationship status, educational degree, occupation, and hobbies.

6. The method of claim 1, further comprising providing a total number of social media users associated with the status indicator on the map interface.

7. The method of claim 5, further comprising selecting a set radius on the map interface to define a geographical boundary for displaying the status indicator.

8. The method of claim 1, wherein the status indicator comprises a name of a business.

9. A system comprising:
a processor;
a memory attached to the processor;
a computer readable medium having instructions embedded therein, the instructions configured to cause the processor to perform the operations of:
parsing through social media data of a social media user extracted from a social media platform;
creating a status indicator comprising one or more categorical labels to filter the social media data into select categories of interest;
correlating the status indicator with location information;
outputting the status indicator with location information on a map interface; and
presenting through a graphical user interface the status indicator with the location information.

10. The system of claim 9, wherein the social media data comprises extracting sentiment information from comments and activities posted by the social media user on the social media platform.

11. The system of claim 10, wherein the social media data comprises personal information comprising a social media user's gender identification, relationship status, educational degree, occupation, hometown information, and hobbies.

12. The system of claim 9, further comprising providing a total number of social media users associated with the status indicator on the map interface.

13. The system of claim 13, wherein the map interface updates the number of social media users associated with the status indicator on the map interface in real time.

14. The system of claim 9, wherein the status indicator includes a name of a business.

15. The system of claim 9, wherein the categorical labels comprise an age group, gender identification, relationship status, educational degree, occupation, and hobbies.

16. The system of claim 9, further comprising selecting a set radius on the map interface to define a geographical boundary for displaying the status indicator.

17. A system comprising:
a processor;
a memory attached to the processor;
a computer readable medium having instructions embedded therein, the instructions configured to cause the processor to perform the operations of:
parsing through social media data of a social media user extracted from a social media platform;
associating a business with a status indicator, wherein the status indicator is a categorical label to indicate a name of a business;
correlating the status indicator with location information;
outputting the status indicator with location information on a map interface; and
presenting through a graphical user interface the status indicator with the location information.

18. The system of claim 17, further comprising selecting a set radius on the map interface to define a geographical boundary for displaying the status indicator.

19. The system of claim 17, further comprising indicating a number of social media users located at the business in real time based on location information of the social media user.

20. The system of claim 17, wherein the categorical labels comprise an age group, gender identification, relationship status, educational degree, occupation, and hobbies.
